(19) United States
(12) Patent Application Publication
(10) Pub. No.: US 2024/0280203 A1
(43) Pub. Date: Aug. 22, 2024

(54) CYLINDER PIPE ASSEMBLY AND METHOD FOR PRODUCING THE SAME

(71) Applicant: BÜMACH ENGINEERING INTERNATIONAL B. V., TA Emmen (NL)

(72) Inventor: Josef Bueter, Haren/Altenberge (DE)

(21) Appl. No.: 18/684,917

(22) PCT Filed: Aug. 18, 2021
(86) PCT No.: PCT/DE2021/000136

§ 371 Date: Feb. 20, 2024

(51) Int. Cl. F16L 41/08

(52) U.S. Cl. CPC F16L 41/082

(57) ABSTRACT

A cylinder pipe assembly has a connection piece, and cylinder pipe with a main body and a connection portion. The connection portion has an outer shell calotte on a cylinder pipe outer shell and an inner shell calotte on a cylinder pipe inner shell, a connection hole, and a structural consolidation zone surrounds the connection hole. The calottes are concave embossed portions. The structural consolidation zone is arranged in a region between the calottes. The connection hole is punched and passes through the calottes. The connection piece is arranged at the connection portion and has a pressure medium tube and a connecting portion with an annular axial boundary contour that with an annular mating surface defines an annular contact surface. The cylinder pipe and the connection piece are connected in a bonded manner by an annular weld seam, and the weld seam defines a sealing plane.

The invention relates to a cylinder pipe assembly, in particular the connection of a cylinder pipe to a connection piece, and to a method for the production thereof.

In the prior art, different ways of connecting a connection piece to a cylinder pipe are described. Screw connections are possible and also material-bonded connections are known, for example achieved by welding.

A screw connection is mostly designed such that there is an internal thread in the cylinder pipe and a corresponding external thread on the connection piece. The internal thread in the cylinder pipe is usually a radial bore hole produced orthogonally to the cylinder axis. The disadvantage of this solution is that the screw-in area of the cylinder pipe must have a minimum thread depth to ensure sufficient mechanical strength of the threaded connection. Consequently, the area of the cylinder pipe must have a great wall thickness or be machined in a cost-intensive and time-consuming manner. Moreover, a great wall thickness is counterproductive for a material-efficient design.

In an alternative design, the connection piece can be welded directly to the cylinder pipe. The usual welding processes, such as TIG, MAG or laser welding, can be used. In most cases, a filler material is added to bridge the joint gaps caused by the outer curvature of the cylinder pipe. Alternatively, milling off the outer curvature is also a known process but this method is disadvantageously associated with a local weakening of the cross section of the cylinder pipe. Furthermore, the high heat input into the cylinder pipe material is also a disadvantage of the welding processes mentioned. This results in structural changes that have a negative effect on strength. Moreover, there is also a risk of unwanted deformation of the cylinder pipe in this area.

Another disadvantage is that the bore holes or threads for the pressure medium connection or the pressure medium flow are produced by drilling or milling. Resulting chips and dust can accumulate in the cylinder interior and contaminate the oil and other peripherals, such as valves or similar members, during the subsequent operation of the working cylinder. In order to avoid this disadvantage, extensive cleaning must be carried out.

Another disadvantage of all known solutions is the fact that the point of passage at which the bore hole reaches the cylinder inner wall forms a contour which leads to increased wear of seals or guides on the piston or which has to be extensively reworked to prevent such undesirable effects.

The object of the invention is to overcome the disadvantages of the prior art by providing a high-quality, heavy-duty cylinder pipe assembly comprising a cylinder pipe with a connection piece arranged thereon, which, furthermore, can be manufactured in a time-saving and cost-effective manner

With regard to the cylinder pipe assembly, the task is solved by the features listed in claim 1 and with regard to the method for its production the task is solved by the features listed in claim 7. Preferred embodiments result from the corresponding sub-claims.

The cylinder pipe assembly has a cylinder pipe and a connection piece as its basic components.

A cylinder pipe is understood to be any hollow cylindrical shell of a hydraulic or pneumatic assembly, preferably a cylinder pipe of a hydraulic working cylinder or a cylinder pipe of a hydraulic valve, in particular a hydraulic control valve or non-return valve.

If it is a cylinder pipe of a hydraulic working cylinder, the piston unit is arranged in the cylinder pipe in such a manner that it can be moved axially. To achieve a movement of the piston unit in the casing, a pressure medium is applied to the cylinder pipe. According to the disclosed cylinder pipe assembly, the pressure medium is led in or out laterally through the cylinder pipe.

According to the invention, the cylinder pipe has a cylinder main body and a connection portion.

The cylinder main body is understood to be the basic tubular structure of the cylinder pipe.

The fluid is guided via the connection portion as a part of the cylinder pipe into the pressure medium working chamber formed by the cylinder pipe, also known as the cylinder interior. The connection portion in turn has an outer shell calotte, which is arranged on a cylinder pipe outer shell, and an inner shell calotte, which is arranged on a cylinder pipe inner shell. The outer shell calotte and the inner shell calotte are also referred to collectively as the calottes.

The cylinder pipe assembly according to the invention is characterized in particular by the fact that the calottes are designed as cold-formed concave embossed portions and create a structural consolidation zone in a forming area between the calottes.

From a geometric point of view, the calottes are designed as formed portions that are concave relative to the remaining surface contour of the cylinder pipe outer shell and the cylinder pipe inner shell and, thus, form a recess and have preferably a or oval shape.

The structural consolidation of the structural consolidation zone advantageously forms a mechanically more stable area due to the fact that the cylinder pipe material is improved in its structure in a cold-formed manner there as a result of the embossed forming of the calottes.

In addition, the connection portion has a connection bore hole (penetration) that is designed such that a pressure medium can pass through the cylinder pipe so that, depending on the operating state, said bore hole functions as a pressure medium inlet or pressure medium outlet. According to the invention, the connection bore hole is designed as a punched bore hole and passes through the two calottes and the cylinder pipe located between them. The working pressure medium can be guided into the cylinder interior via the bore hole.

The solution according to the invention is further characterized in particular by the fact that the connection bore hole is enclosed by the structural consolidation zone.

Thus, the critical area of the pressure medium inlet and the pressure medium connection provides a greater mechanical strength.

The connection piece is arranged on the connection portion and has a pressure medium tube which is designed for a pressure medium passage of the pressure medium.

A pressure medium connection of the connection piece, for example designed as a threaded portion, offers the possibility to connect a pressure medium hose to the connection piece and indirectly to the cylinder and thus supplying or discharging the pressure medium. Depending on the installation situation and operating condition, such a pressure medium hose can be deformed during dynamic movements of the cylinder so that it applies a mechanical load on the connection piece and indirectly on the cylinder pipe in the area that is inevitably weakened by the bore hole anyway. Here, a more durable connection option with a higher load-bearing capacity is provided by the structural consolidation.

In addition, the connection portion has a connecting portion with an annular axial boundary contour that surrounds the pressure medium channel.

Furthermore, the outer shell calotte also has an annular contour that forms an annular mating surface to the annular axial boundary contour of the connection piece.

The annular axial boundary contour according to the invention and the annular mating surface of the outer shell calotte form an annular contact surface. Advantageously, the annular contact surface is practically gap-free. Due to the annular contact and the calotte-shaped embossing, the connection piece can be fitted with a high tolerance and, nevertheless, a sealing contact is possible. With an outer shell calotte designed as a spherical surface section in particular, a practically gap-free annular contact surface is always achieved, even if the connection piece deviates from an ideal radius relative to the longitudinal axis of the cylinder pipe.

The cylinder pipe and the connection piece are connected to each other at the annular contact surface by means of an annular weld seam. Hereinafter, the cylinder pipe and the connection piece are also referred to collectively as the join partners. The annular weld seam also forms the sealing plane.

Furthermore, the pressure medium tube and the connection bore hole as a pressure medium passage through the cylinder wall form a common pressure medium channel.

By means of the cylinder pipe assembly according to the invention, a solution has been surprisingly found that solves a large number of problems of the state of the art in a technologically simple and reliable manner under the advantageous aspects described in more detail below.

Advantageously, the cylinder pipe assembly according to the invention is obtained by a chip-free production so that chips that could enter the cylinder interior and cause damage there are not produced. This fact increases cleanliness and quality in the production.

It is also advantageous that burr formation on the connection bore hole is ruled out by two-sided embossing. In particular, this eliminates the need for reworking to remove burrs. The grinding marks that often remain after reworking are also avoided. Advantageously, there is a smooth wall at the connection bore hole so that the flow of the pressure medium is not disturbed and can take place in a homogeneous and low-noise manner.

In this context, there is also the advantage that, without additional measures, the transition between the inner shell surface of the cylinder and the inner shell calotte is also free of burrs due to the embossed forming. In this way, the point at which the connection bore hole penetrates to the inner shell calotte is also advantageously slightly recessed radially relative to the contour of the cylinder inner shell surface so that sensitive components, such as seals or guides on the piston, are particularly protected when they are passing the connection bore hole.

The embossed forming also provides an advantageous structural change through material compaction in the structural consolidation zone, i.e., in the area around the connection bore hole. This is particularly advantageous in that the connection bore hole inevitably results in a structural weakening of the cylinder pipe wall, which must distribute the buckling stress and the axial tensile stress around the connection bore hole. In addition, depending on the application, bending forces can also be introduced via the connection piece. This critical area is strengthened by the advantageous structural change and can therefore better compensate for the structural weakening caused by the connection bore hole.

Furthermore, the outer shell calotte advantageously provides an annular mating surface as a counter surface for a flush and gap-free contact of the connection piece so that optimum conditions are created for a particularly high-quality welded joint that is also free of welding material.

A further advantage is that the shapes or contours of the outer and inner shell calotte can also differ from each other so that it is possible to provide special shapes, such as longitudinally extended inner shell calottes, for forming a damping pressure medium channel in the cylinder inner shell surface without additional steps.

Furthermore, it is advantageous that the connection bore hole, the structural consolidation zone, the annular mating surface of the outer shell calotte and the burr-free passing of the connection bore hole into the cylinder inner shell surface are made in just one uniform work step, thus enabling a cost-effective and efficient production.

The connection bore hole production by punching produces a plug, also called a slug, which can be completely reused as clean solid scrap. Furthermore, the energy consumption in the production for the disclosed punching and embossing process is significantly lower than for the multi-stage machining processes according to the state of the art. And, advantageously, contaminated chips which would be costly to dispose of are not produced.

According to an advantageous further development, the cylinder pipe assembly is characterized in that the cylinder pipe assembly is designed as a part of a working cylinder.

In a particularly preferred embodiment, this further development is a cylinder assembly of a hydraulic working cylinder. This cylinder type is exposed to extremely high load so that the described advantages of high quality and strength are particularly effective. Such a working cylinder comprises the cylinder pipe assembly and a piston unit and is used as a linear pressure flow consumer in many fields of application.

According to another advantageous further development, the cylinder pipe assembly is characterized in that the annular weld seam is formed as a pressure weld seam.

The pressure weld seam offers the advantage that the structure in the area surrounding the weld is changed less than in other welding processes, especially as the heat input into the material of the welding partners is extremely low.

The advantageous further development as a pressure weld seam is possible because the solution according to the invention creates a practically gap-free contact surface by providing the annular mating surface of the outer shell calotte to the annular axial boundary contour of the connection piece.

According to a further advantageous development, the cylinder pipe assembly is characterized in that the annular weld seam is formed without welding material. The advantage of this development is that no filler material is required for welding.

Therefore, welding can be carried out advantageously with a lower energy input, technologically simpler and faster and without the occurrence of welding spatter. In addition, material contamination with an added welding material, which could lead to increased corrosion or structural distortions, does not occur in the welding joint.

According to another advantageous further development, the cylinder pipe assembly is characterized in that the outer shell calotte is designed as a spherical surface section.

Due to the spherical shape, the structural transition along the cylinder pipe wall in the direction of the connection bore hole as a part of the pressure medium channel is a gradual transition which prevents structural fissures. This avoids the formation of cracks or dynamic fractures.

The forming of the outer shell calotte as a spherical surface section also has the advantage that a circular line can be geometrically inscribed on the surface of the outer shell calotte. In addition, the plane of this circular line can be arranged at different angles so that the connection piece can be aligned in a particularly easy manner and a gap-free annular contact surface can always be achieved.

According to another advantageous further development, the cylinder pipe assembly is characterized in that the inner shell calotte is designed as a damping pressure medium channel.

This further development relates to damping solutions in which the piston has a piston ring and the connection bore hole in the cylinder end region is offset in an axially-proximal direction so that the piston passes over the connection bore hole with its piston ring when approaching the end position and thus encloses a pressure medium volume in the cylinder end region. If the piston passes over the inner shell calotte with its piston ring, the pressure medium channel is not completely closed by the piston. Instead, in the inner shell calotte formed in this way, a small amount of the pressure medium can flow past the piston ring of the piston. Thus, a damping of the piston movement can be achieved. The cross section of the damping pressure medium channel determines the degree of damping and its axial extension determines the damping path. In a special embodiment, progressive damping can also be achieved by means of a cross section with a variable axial extension.

According to a further aspect of the invention, the cylinder pipe assembly is obtained by a production method described in more detail below.

The method for producing a cylinder pipe assembly is characterized in that the cylinder pipe assembly is designed according to one of claims 1 to 6 and has the following process steps:

### a) Providing the Cylinder Pipe

The starting point of the process is a cylinder pipe, which is obtained from a rod material by cutting to length, turning and, if necessary, other work steps.

The cylinder pipe provided in this way is placed in a device. The device consists of a press, which can perform a lifting movement, and a tool with a defined holder for the pipe. In this way, the pipes are always inserted in the same position during series production and processing always takes place at the same point of the pipe.

### b) Punching the Connection Bore Hole and Forming the Calottes by Using a Punch-Forming Die and a Counter-Die in a Cold Forming Process

The punch-forming die has a preferably spherical section shaped embossing contour and a cylindrical cutting pin that penetrates the centre of the spherical section. The die also protrudes from the spherical section by at least the length of the single wall thickness of the cylinder pipe.

In the punching phase of process step b), the cutting die contour penetrates into the cylinder pipe and punches the connection bore hole as a cylindrical aperture.

After a continued movement of the die, the preferably spherical section embosses the outer shell calotte into the cylinder pipe outer side in the embossing phase. The counter-die provides the counterforce. To do this, it takes on the inner shape of the cylinder pipe. The counter-die also has a preferably spherical convex contour and thus forms the inner shell calotte at the same time as the outer shell calotte is formed. In addition, a cylindrical aperture, into which the punched-out cylinder slug and the cutting die section immerse, goes through the counter-die.

During the embossing phase, the cutting die, which is still in the connection bore hole, advantageously supports the inner walls of the connection bore hole so that the material of the cylinder pipe, which forms plastically in the structural consolidation zone during embossing, is particularly compressed at the inner walls. At the same time, the aperture cross section of the connection bore hole is protected from deformation.

Furthermore, it is possible to carry out a further embossing step with a different embossing tool following process step b) in order to remove any burr from the connection bore hole or to continue to form the calottes.

According to a further aspect of the invention, process step b) can also be carried out in two sub-steps. In a first sub-step, the connection bore hole is punched by means of a punching die and in a second sub-step, the calottes are embossed by means of an embossing die so that any punching burr is simultaneously pressed in and thus removed.

In an advantageous variant, process step b) can also be carried out simultaneously for both pressure medium connections in the case of a cylinder pipe that is to have two lateral pressure medium connections-one pressure medium connection in each end region-so that a cylinder pipe with the connection portion at one end region and a further connection portion at the other end region is provided after this process step. For this purpose, the press has a further embossing die and a further counter-die in this further development in addition to the embossing die and the counter-die. The two counter-dies are positioned on both sides in the cylinder pipe interior where the respective connection portion is to be produced. Then, both embossing dies can be actuated in one press stroke. This applies in particular to cylinder pipe assemblies for double-acting working cylinders such as differential cylinders or cylinders which have a continuous piston rod and thus two equally large effective surfaces for extending and retracting.

c) Positioning the Connection Piece on the Outer Shell Calotte and Establishing a Fixed Positional Relationship while Forming the Annular Contact Surface and Obtaining a Pre-Assembly

The connection piece is positioned in the area of the outer shell calotte with its annular contact surface. Due to the combination of the shape of the outer shell calotte and the annular contact surface of the connection piece, a high angular tolerance exists during positioning and fitting. There is always a complete gap-free contact between the joining partner geometries, which leads to a homogeneous, materially bonded connection after the next process step.

### d) Welding the Cylinder Pipe and the Connection Piece Thus Producing the Annular Weld Seam 17

Welding is preferably carried out by producing a resistance pressure weld with pressing of the joining partners.

Welding is used to create a tight and materially bonded connection between the cylinder pipe and the connection piece. Moreover, the connection is impermeable to pressure media. Due to the gap-free pre-positioning of the joining partner geometries, welding can be carried out in a high quality without the need for cost-causing reworking.

Now, a pressure medium fluid supplier in the form of a hose or tube can be installed to the cylinder pipe. The connection between the connection piece and the cylinder pipe also offers sufficient resistance against dynamic loading resulting from the movement of the hose which is caused by pressure surges or the cylinder movement.

Like process step b), the two process steps c) or d) can optionally also be carried out simultaneously for two connection portions.

In an advantageous further development, the process for producing a cylinder pipe assembly is characterized in that in process step b) punching and forming are carried out by means of a counter-die designed as a hardened sphere.

Therefore, the counter-die also has a convex area shaped like a spherical section. This is embossed into the inner side of the cylinder pipe and also forms a concave calotte here.

By forming the counter-die with a hardened sphere, a cost-effective embossing tool with high process stability can be advantageously provided.

According to another advantageous further development, the process for producing a cylinder pipe assembly is characterized by the fact that in process step d) welding is carried out as a resistance pressure welding.

Due to the continuous annular and gap-free support of the connection piece on the shape of the outer shell calotte, the supplied energy is distributed evenly. As a result, an exact and fluid-tight weld seam is achieved without the need to input additional material.

The invention is explained in more detail as an exemplary embodiment by means of the following figures They show:

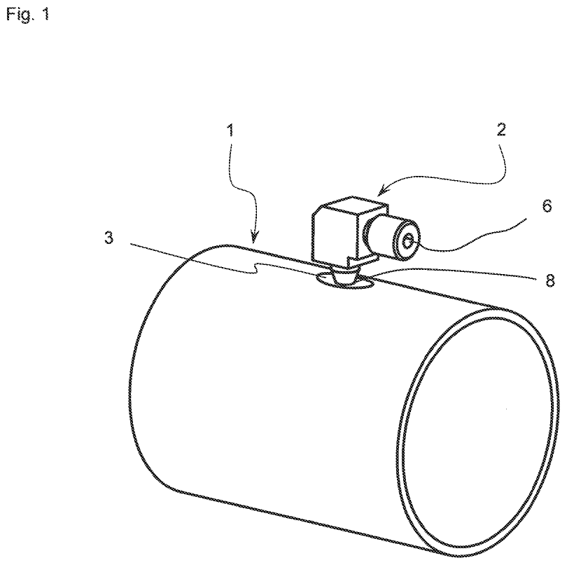

FIG. 1 a schematic oblique view of a cylinder pipe assembly

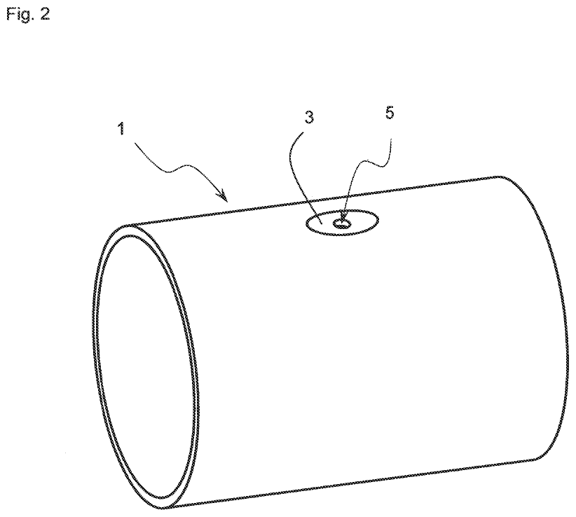

FIG. 2 a schematic oblique view of the cylinder pipe

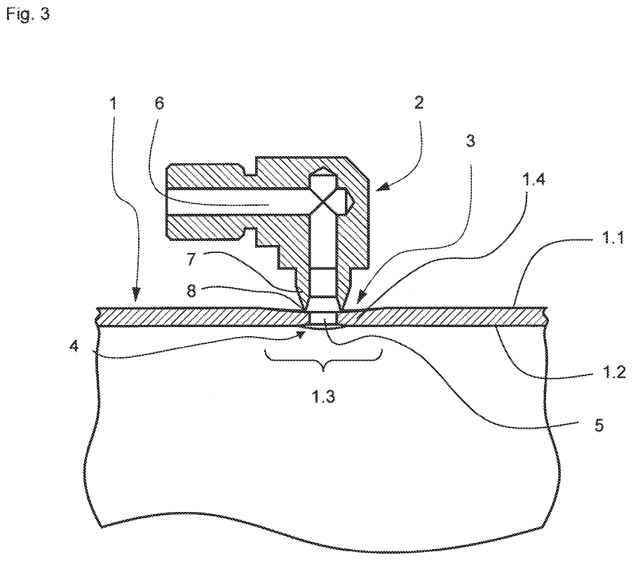

FIG. 3 a schematic sectional view along the cylinder pipe axis

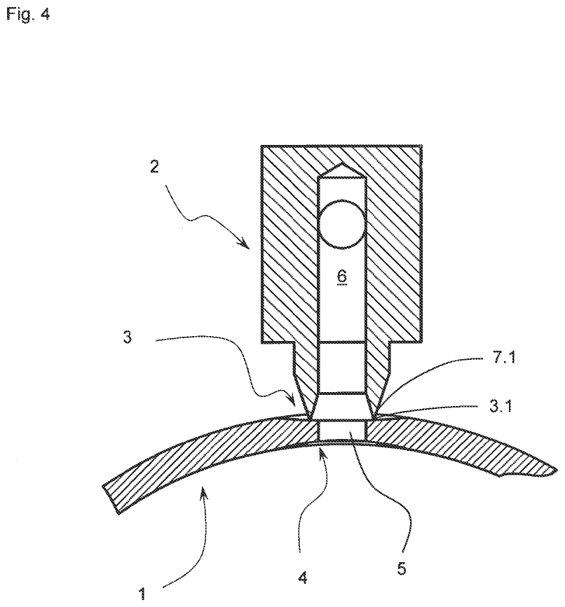

FIG. 4 a schematic sectional view perpendicular to the cylinder pipe axis

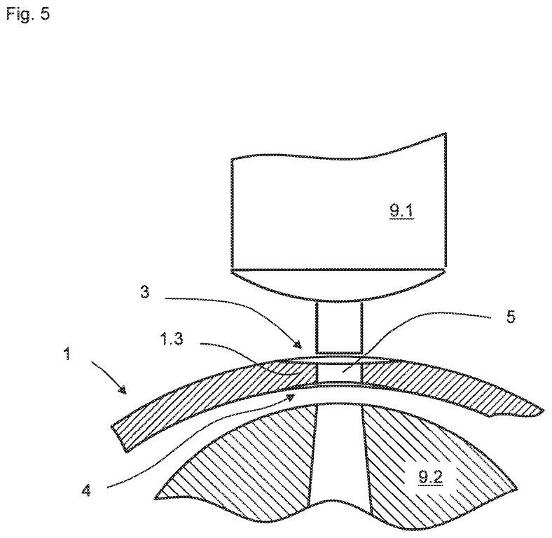

FIG. 5 a schematic sectional view of the punching and embossing tool.

It is to be noted that the same reference numerals in the various figures refer to the same features or components. The reference numerals are also used in the description if they are not shown in the relevant figure.

FIG. 1 shows a schematic oblique view of the entire cylinder pipe assembly. In FIG. 1, the cylinder pipe 1 is connected to the connection piece 2. In the area of the outer shell calotte 3, the connection piece 2 is joined in a materially bonded manner by means of the annular weld seam 8.

FIG. 2 shows a schematic oblique view of the cylinder pipe 1 prepared for joining Here, a spherical section shaped outer shell calotte 3 is embossed on the outer shell surface of the cylinder pipe. The connection bore hole 5 is also punched in for the flow of pressure medium.

FIG. 3 shows a sectional view of the entire cylinder pipe assembly, cut along the longitudinal axis of the cylinder pipe.

In the area of the connection portion 1.3, a spherical section shaped outer shell calotte 3 is embossed into the cylinder pipe 1 on the cylinder pipe outer shell 1.1. Opposite this, the inner shell calotte 4 with also a spherical section shaped contour is embossed into the cylinder pipe 1 on the cylinder pipe inner shell 1.2. Depending on the penetration depth, the structure of the cylinder pipe material is compressed by a defined value. This compression results in a localized hardening of the material. This is the structural consolidation zone 1.4.

At the same time, a connection bore hole 5, which is provided for the pressure medium flow, is punched in.

The connection piece 2 has the pressure medium tube 6 for the pressure medium passage. Furthermore, the connection piece 2 has the connecting portion 7 with an annular end contour. This is the annular axial boundary contour 7.1. In a joining position, the annular mating surface 3.1 of the outer shell calotte 3 is located opposite this annular axial boundary contour 7.1.

The connection piece is placed on the outer shell calotte 3 and joined in a materially bonded manner by the annular weld seam 8 which has been produced by pressure welding and also forms the sealing plane for the pressure medium. Then, the pressure medium can flow into the interior of the cylinder pipe 1 via the connection piece 2 through the connection bore hole 5 and vice versa.

FIG. 4 shows a sectional view of the cylinder pipe assembly, cut diagonally the longitudinal axis of the cylinder pipe.

In combination with FIG. 3, FIG. 4 shows in particular the spherical section shaped contours of the outer shell calotte 3 and the inner shell calotte 4. When the cylinder pipe 1 is joined to the connection piece 2 in process step c), the annular axial boundary contour 7.1 of the connection piece 2 and the annular mating surface 3.1 as a surface section of the spherical section concave surface of the outer shell calotte 3 are opposite each other without a gap. Even if the joining partners 1, 2 are tilted towards each other with a large angular deviation, the shape of the outer shell calotte 3 ensures a gap-free and sealing contact after welding.

During the subsequent pressure welding in process step d), a uniform energy input and, as a result, a pressure-tight, materially bonded connection is achieved by means of the annular weld seam 8. The pressure medium can flow into the interior of the cylinder pipe 1 without interference via the connection bore hole 5 and the downstream inner shell calotte 4.

FIG. 5 shows a schematic sectional view of the punching and embossing tool for the process of machining the connection portion 1.3 of the cylinder pipe 1 for the subsequent joining of the connection piece 2.

Here, the cylinder pipe 1 provided in process step a) is positioned on a counter-die 9.2. In process step b), the die is inserted from the outside of the cylinder pipe 1. The punch-forming die 9.1 consists of a cylindrical punching section that is arranged on a punched section designed as a spherical section. Thus, the connection bore hole 5 can be punched into the cylinder pipe 1 with the punch-forming die 9.1 and the outer shell calotte 3 and the inner shell calotte 4 are simultaneously embossed in the same press stroke.

In the present exemplary embodiment, the counter-die 9.2 also has a spherical section shaped embossing contour. This means that the inner shell calotte 4 can be embossed in the same work step. In addition, the counter-die 9.2 has a conical bore hole in the centre, which accommodates the punching slug and the cylindrical form section of the punch-forming die 9.1. This tool structure can be used to produce the entire required joining contour on the cylinder pipe 1 with just one press stroke.

### REFERENCE NUMERALS

1 Cylinder pipe
1.1 Cylinder pipe outer shell
1.2 Cylinder pipe inner shell
1.3 Connection portion
1.4 Structural consolidation zone
2 Connection piece
3 Outer shell calotte
3.1 Annular mating surface
4 Inner shell calotte
5 Connection bore hole
6 Pressure medium tube
7 Connection portion
7.1 Annular axial boundary contour
8 Annular weld seam
9.1 Punch-forming die
9.2 Counter-die

1-9. (canceled)

10. A cylinder pipe assembly, comprising:
a cylinder pipe and a connection piece, said cylinder pipe having a cylinder main body and a connection portion, said connection portion having an outer shell calotte arranged on a cylinder pipe outer shell, an inner shell calotte arranged on a cylinder pipe inner shell, a structural consolidation zone and a connection hole, and said calottes being constructed as cold-formed concave embossed form portions, said structural consolidation zone being arranged in a forming area between the calottes, said connection hole being a punched hole passing through the calottes configured for a passage of a pressure medium and said structural consolidation zone surrounding said connection hole;
said connection piece being arranged at the connection portion and having a pressure medium tube and a connecting portion, said pressure medium tube being constructed for passage of the pressure medium, said connecting portion having an annular axial boundary contour, said annular axial boundary contour and an annular mating surface of said outer shell calotte defining an annular contact surface, said cylinder pipe and said connection piece being connected in a materially bonded manner at said annular contact surface by an annular weld seam and said annular weld seam defining a sealing plane, said pressure medium tube and said connection hole defining a common pressure medium channel.

11. The cylinder pipe assembly according to claim 10, wherein the cylinder pipe assembly is constructed as part of a working cylinder.

12. The cylinder pipe assembly according to claim 10, wherein said annular weld seam is configured as a pressure weld seam.

13. The cylinder pipe assembly according to claim 10, wherein said annular weld seam is formed without welding material.

14. The cylinder pipe assembly according to claim 10, wherein said outer shell calotte is constructed as a spherical surface section.

15. The cylinder pipe assembly according to claim 10, wherein said inner shell calotte is constructed as a damping pressure medium channel.

16. A method for producing a cylinder pipe assembly according to claim 10, comprising:
a) providing the cylinder pipe,
b) punching the connection hole and forming the calottes with a punch-forming die and a counter-die in a cold forming process
c) positioning the connection piece on the outer shell calotte and establishing a fixed positional relationship while forming the annular contact surface and obtaining a pre-assembly,
d) welding the cylinder pipe and the connection piece for producing the annular weld seam.

17. The method for producing a cylinder pipe assembly according to claim 16, wherein in process step b) punching and forming are carried out by of a counter-die constructed as a hardened sphere.

18. The method for producing a cylinder pipe according to claim 16, wherein in in process step d) the welding is a resistance pressure welding.
